(19) United States
(12) Patent Application Publication
(10) Pub. No.: US 2011/0062345 A1
(43) Pub. Date: Mar. 17, 2011

(54) TRITIUM SENSOR AND METHOD

(75) Inventors: Stephen N. Paglieri, Los Alamos, NM (US); Scott Richmond, White Rock, NM (US)

(73) Assignee: LOS ALAMOS NATIONAL SECURITY, LLC, Los Alamos, NM (US)

(21) Appl. No.: 12/680,403

(22) PCT Filed: Aug. 13, 2008
(86) PCT No.: PCT/US08/73024

§ 371 Date: Nov. 30, 2010

Related U.S. Application Data
(60) Provisional application No. 60/972,269, filed on Sep. 14, 2007.

(51) Int. Cl. G01T 1/00

(52) U.S. Cl. 250/395; 250/336.1

(57) ABSTRACT

A tritium sensor and method are provided. The sensor involves the use of an electrode having a semiconductor coating that has properties selected to allow the passage of beta particles at the particular energy level for tritium through the semiconductor layer to a conductive electrode core and produce current. Current flow in the core can be measured by a current measuring device. The current flow can be correlated to the concentration of tritium in the gas surrounding the electrode to provide an indication of the amount of tritium present. The device can be used in a static system or a system in which the tritium containing gas flows. The apparatus provides real time readings of the tritium concentration in gas.

### STATEMENT REGARDING FEDERAL RIGHTS

This invention was made with government support under contract number DE-AC52-06NA25396 awarded by the U.S. Department of Energy. The government has certain rights in the invention.

### BACKGROUND OF THE INVENTION

Tritium is an isotope of hydrogen. It occurs both naturally and as a bi-product of nuclear reactions. The measurement of the concentration of tritium can be important to know both its level for use and its concentration in processing streams. The measurement of tritium level in real time has proven to be difficult. The current state-of-the-art technologies for measuring tritium are ion chambers, beta-scintillation, mass spectrometers and calorimeters. The problems with such measurement devices are that they require trained operators, the equipment is large and/or expensive and most do not provide real time measurements. The equipment used is expensive and some may not necessarily be accurate depending upon the concentration of the tritium and the test environment.

At low levels of concentrations, modern, commercially available ion chambers are real time, but they are generally not accurate above about 100 Ci/m³ concentrations and they are susceptible to gas-density variations, recombination, wall effects, saturation, and memory effects. The implementation of large scale fusion reactors, e.g., the International Thermonuclear Experimental Reactor (ITER), creates a need for a low cost, accurate tritium sensing device that works at common process pressures, e.g., 50 psia and in real time.

Ion chambers are excellent for measuring low level tritium concentrations, about 100 nCi/m³, but are somewhat pressure sensitive and some units saturate at 1-1000 Ci/m³, are sensitive to gas composition and are prone to drift from tritium contamination and background signals.

Beta-scintillation detectors (non-liquid) are repeatable and accurate (0.1%-100% T₂), that are fairly limited in pressure range (about 0.1-10 torr) and require sampling and analysis by a skilled operator.

Calorimetery can accurately measure very high tritium concentrations including tritium in solids and inside containers but is slow and requires large and expensive equipment, is not adapted for measuring low concentrations, i.e., concentrations below about 10,000 Ci/m³ and also requires a skilled operator.

Mass spectrometry is repeatable and accurate and can measure nearly all gas species possibly as low as 50 ppm but consists of large and expensive equipment, typically takes hours to effect an analysis, has a high initial and maintenance cost and also requires a skilled operator.

There is thus a need for an improved method and apparatus for measuring tritium concentration.

### SUMMARY OF INVENTION

The present invention involves the provision of a tritium sensor comprising a housing with an electrode. The electrode has a conductive core with an outer surface that is coated with a dielectric material that allows beta particles that are released from decaying tritium to pass therethrough and remain captured in the underlying electrode core which will cause a current flow in the electrode core which current may be sensed and measured by a suitable current meter. The current meter can be calibrated to display the concentration of tritium contained in the space between the electrode and the housing. Suitable dielectric coatings include alumina, beryllia, nanocrystalline diamond, and aluminum nitride. The coatings on the electrode are thin and may be deposited by vapor deposition. The gas sampling space surrounding the electrode is configured to provide a gap thickness of less than about 1 mm.

The present invention also involves the provision of a method of measuring a concentration of tritium in a gaseous environment. The method includes exposing an electrode to a gas containing tritium. The decaying tritium is exposed to a semiconductor layer on an electrode core which permits the beta particles which are a result of tritium decay to pass through the semi-conducting layer to a conductive electrode core on which the semiconductor layer is coated. A current flow is induced in the electrode which is then measured by a suitable current meter. An output signal is provided to indicate the amount of current flow which current flow is indicative of the amount of tritium contained in the gas.

### BRIEF DESCRIPTION OF THE DRAWINGS

FIG. 1 is a schematic side elevation sectional view of a tritium sensor.

FIG. 2 is a schematic illustration of the tritium sensor showing only a portion of the sensor with a schematic illustration of a current detector.

FIG. 3 is a graph illustrating operation of a tritium sensor.

Like numbers throughout the various Figures designate like and/or similar parts and/or construction.

### DETAILED DESCRIPTION

The reference numeral 1 designates generally a tritium sensor which includes a current sensing and measuring device designated generally 2 and an electrode 3. When beta particles are released during decay of tritium some pass through a dielectric layer 4 of electrode 3 with a substantial portion of these beta particles not being able to return to the tritium gas side of the layer 4. The particles, which are negatively charged, cause a current flow in a conductive electrode core 5. The current flow in the core 5 is sensed by the current measuring device 2 which signal can be correlated to and displayed as the amount of tritium in the gas surrounding the electrode 3. The electrode 3 is contained in a hermetically sealed housing 7. The exterior of the electrode 3 is contained within a chamber 8 which has an interior surface 9 closely spaced to the exterior of the electrode 3. The gap between the exterior of the electrode 3 and the surface 9 is such as to be less than the range of the most energetic decay electrons or beta particles. Tritium beta particles have an energy level that varies widely and the apparatus 1 is configured to capture beta particles with an energy level in the range of between about 14 keV and about 18 keV.

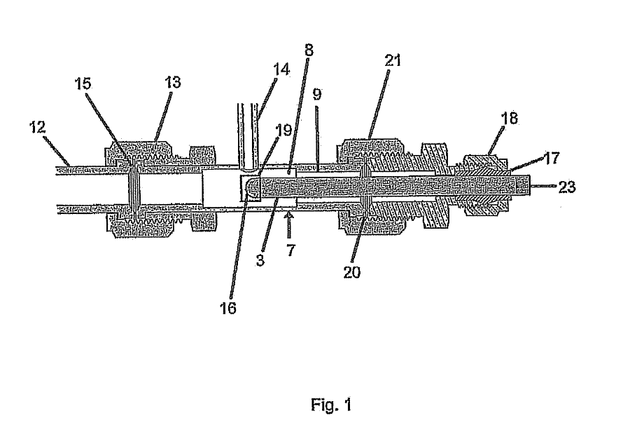

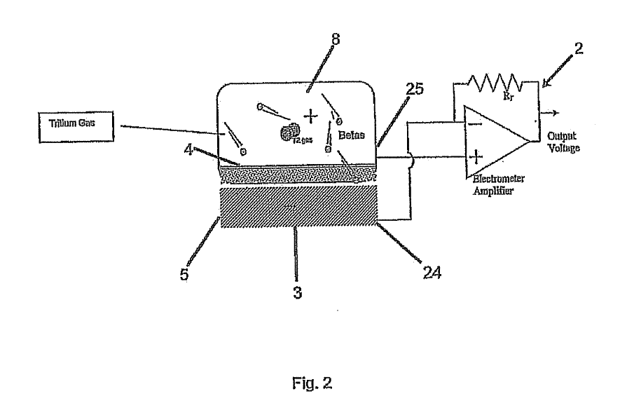

The sensor device 1 as seen in FIG. 1 includes a housing 7 which is in turn connected to a tritium gas feed or inlet 12 which can be in the form of a pipe or a vessel to which the housing 7 is connected in flow communication. To induce flow into and out of chamber 8, an outlet 14 can also be connected in flow communication with the chamber 8 to provide flow into and out of the chamber 8. The housing 7 may be connected to the inlet 12 using a radioactive hardened seal 15 and a threaded coupling 13. The electrode 3 is positioned in the housing 7 having a free or distal end 16 positioned in the chamber 8. An insulating cover 19 may be secured to and enclose the distal end 16 to improve measurement precision. A substantial portion of the electrode 3 is positioned in the chamber 8 and is spaced from the surface 9 a distance of less than about 1 mm. This distance is less than the range of the most energetic decay electrons of the tritium during decay inducing higher incident impingement on and through the layer 4. The electrode 3 can be sealed to the housing 7 with a radioactive hardened seal 17 which can be held in position with a threaded coupling 18. The seal 17 is electrically insulating and forms a hermetic seal between the housing 7 and the electrode 3. As shown, another radioactive hardened seal 20 is provided between portions of the housing 7 which permits easy assembly of the electrode 3 to the housing 7 as for example with the threaded coupling 21. Preferably, the materials of the housing 7 are resistant to radioactive transmission and may be made of a metal material. A proximal end 23 of the electrode 3 is exposed for connection to the current sensing device 2. The current sensing device 2 is electrically connected to the electrode core 5 and the housing 7 as at 24, 25 respectively as seen in FIG. 2.

The electrode 3 is comprised of an electrode core 5 and a continuous dielectric coating 4. The dielectric coating 4 is preferably a semi-conducting material such as alumina (Al₂O₃), nanocrystalline diamond, aluminum nitride (AlN) and beryllia (BeO). Other electrically insulating coatings could be used. The thickness of the coating is in the range of between about 0.5 μm and about 5 μm and preferably about 1 μm to about 2 μm and has a volume resistivity in the range of between about 10¹³ ohm-cm and about 10¹⁴ ohm-cm. The sensor 1 has been found effective at operating gas pressures of 50 psia and is believed that it will work at significantly higher pressures. A significant change in operating pressure may change some of the above expressed values. The higher the density the coating 4 has, the thinner the coating can be. The coating 4 may be vapor deposited on the electrode core 5 for example by physical vapor deposition or chemical vapor deposition processes which are well known in the art. Prior to coating, it is preferred that the electrode core 5 be highly polished to a mirror finish and that the coating 4 applied thereto has no pin holes or cracks which could adversely affect operation of the sensor 1.

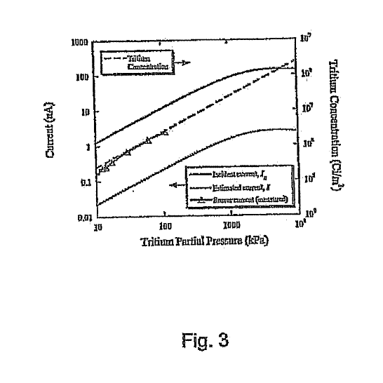

The current measuring device 2 can be any suitable current measuring device and should be able to accurately detect currents on the order of about 0.05 nA to about 1,000 nA. A functional relationship between tritium partial pressure (kPa) as a function of current is shown in FIG. 3. A suitable current sensing device 2 is an electrometer. A preferred electrode core 5 is metallic such as a Kovar rod and a preferred coating is alumina. Kovar is a high nickel/cobalt/ferrous alloy and has a very low coefficient of thermal linear expansion, on the order of glass to help maintain the integrity of the coating 4. Other metal alloys or metals can be used as long as their use does not affect integrity of the coating 4, e.g., stainless steel.

The above described invention is better understood by a description of the operation thereof. Tritium decays into a ³He atom with a 12.323 year half-life resulting in beta electron and anti-neutrino emission. Electrons (betas) from tritium decay pass through the insulating thin coating 4 and are collected in the conductive electrode core 5. With proper selection of coating material and thicknesses, very few of the electrons that pass through the coating 4 are able to escape back to the tritium gas and will produce current in the core 5. The current sensing device 2 measures the current flow in the core 5 and provides a signal related to the amount of tritium surrounding the sensor. A display can be provided to show current flow preferably correlated to and displayed as tritium concentration. It is preferred that the layer 4 be an effective hydrogen barrier with low hydrogen isotope solubility and should provide a low background signal and also be resistant to degradation due to tritium dissolution and radiation damage. The electrode core 5 preferably has a low coefficient of thermal expansion that reasonably matches that of the coating 4. A suitable electrode core 5 was constructed with a diameter of 0.64 cm and had a length of 10 cm. The core 5 was coated with alumina to a thickness of about 1 micron. The gap between the coating layer 4 and the wall 9 was about 1 mm. The core 5 was mounted to the housing 7 as described above. The sensor 1 was then connected to a source of tritium and data was gathered which is shown in FIG. 3. Sensor performance was estimated using simple exponential attenuation estimates for the gas (variable due to pressure change) and alumina (fixed thickness) while taking the cylindrical geometry of the electrode 3 and chamber 8 into account. The most linear performance should be obtained by using a very small, known volume around the sensor to minimize the effects of decay electron attenuation in the gas. Variability and sensor output was attributed to two factors. First, the resistive capacitive time constant or response time of the sensor depending on the configuration of the calibrated electrode meter circuit. The electrical circuit was configured to obtain faster response by adjusting the resistance, thereof. Additionally, the presence of deuterium or helium-3 increases the attenuation of decay electrons in the gas phase at a given tritium partial pressure due to the higher overall pressure.

The method of measuring tritium concentration in a gas includes exposing an electrode having a conductive electrode core coated with a semi-conducting material such as those described above. The tritium decays releasing beta particles which impinge upon the surface of the semi-conductive coating 4 on the electrode core 5. The beta particles then cause a current flow in the core 5 which current flow is measured by the current measuring device 2 providing a real time output signal indicative of the concentration of tritium in the gas in the chamber. The greater the number of tritium particles decaying (i.e., the higher the tritium concentration), the higher the current flow. The current flow can be correlated or calibrated to the amount of tritium present thus providing an indication of the amount of tritium by knowing the current flow. The amount of tritium can be visually displayed.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A tritium sensor comprising:
a housing with a chamber;
an electrode having a portion positioned in the chamber, said electrode having a conductive core portion positioned in the chamber with a semi-conductive coating thereon said coating being effective to allow beta particles from tritium decay to pass therethrough to the conductive core portion, said housing including an interior surface at least partially defining the chamber and being spaced from an exterior surface of the electrode forming a gap having a thickness of less than about 1 mm; and
a current sensing device electrically connected to the conductive core portion and operable to sense current flow in the conductive core portion.

2. The sensor of claim 1 wherein said coating having thickness in the range of between about 0.5 microns and about 5 microns.

3. The sensor of claim 2 wherein the coating having a volume resistivity in the range of between about 10¹³ ohm-cm and about 10¹⁴ ohm-cm.

4. The sensor of claim 3 wherein the conductive core portion having a mirror finish on a surface on which the coating is applied.

5. The sensor of claim 3 wherein the chamber being hermetically sealed from the exterior of the housing.

6. The sensor of claim 5 wherein the housing being resistant to leakage of radiation therethrough.

7. The sensor of claim 3 wherein the coating including one of alumina, nanocrystalline diamond, beryllia and aluminum nitride.

8. The sensor of claim 3 wherein the current sensing device including an electrometer.

9. The sensor of claim 3 wherein the current sensing device having a readout in tritium concentration.

10. The sensor of claim 3 wherein the housing being of a metallic material.

11. The sensor of claim 3 wherein the housing having a flow inlet and a flow outlet in flow communication with the chamber.

12. The sensor of claim 3 wherein the core and the coating having substantially equal coefficients of linear thermal expansion.

13. A method of measuring tritium contraction, the method including:
exposing tritium containing gas to an electrode having a conductive core and a semi-conductive coating having thickness adapted to have tritium beta particles with an energy in the range of between about 14 keV and about 18 keV preferentially pass therethrough to the core and produce current flow;
measuring the magnitude of the current flow; and
correlating the magnitude of current flow to tritium concentration.

14. The method of claim 13 including confining a portion of the tritium containing gas being exposed to the electrode to a maximum distance from the coating of less than about 1 mm.

15. The method of claim 14 including displaying the tritium concentration in real time.
